(19) United States
(12) Patent Application Publication
(10) Pub. No.: US 2011/0123897 A1
(43) Pub. Date: May 26, 2011

(54) MEMBRANE-ELECTRODE ASSEMBLY AND FUEL CELL USING THE SAME

(75) Inventors: Jun KAWAJI, Hitachi (JP); Makoto MORISHIMA, Hitachinaka (JP); Shuichi SUZUKI, Hitachinaka (JP); Yoshiyuki TAKAMORI, Hitachinaka (JP); Atsuhiko ONUMA, Hitachi (JP)

(73) Assignee: HITACHI, LTD.

(21) Appl. No.: 12/951,203

(22) Filed: Nov. 22, 2010

(30) Foreign Application Priority Data
Nov. 26, 2009 (JP) 2009-268893

(51) Int. Cl. H01M 8/10

(52) U.S. Cl. 429/482; 429/535

(57) ABSTRACT

In a membrane-electrode assembly comprising an anode, a cathode and a polymer electrolyte membrane and having a constitution in which the polymer electrolyte membrane is interleaved between the anode and the cathode, an agglomerate structure of carbon support formed with a plurality of carbon primary particles supporting catalyst particles is contained in the anode and the cathode, and particulate media having polymer electrolyte on the surface thereof are contained between adjacent agglomerate structures of carbon supports.

### BACKGROUND OF THE INVENTION

The present invention relates to a membrane-electrode assembly and a fuel cell using the same.

A fuel cell is a device which converts chemical energy directly to electric energy.

The fuel cell is a device in which a reductant agent such as hydrogen, methanol and the like as a fuel and an oxidizing gas such as air, oxygen and the like as an oxidant agent are supplied to a fuel electrode (anode) and an air electrode (cathode), respectively, and electrons generated by a redox reaction progressing on catalysts contained in an electrode layer is taken out and utilized as electric energy.

Generally, in the fuel cell, the fuel is electrochemically oxidized in the anode, and oxygen is reduced in the cathode, and hence an electric potential difference is generated between both electrodes. In such case, if a load is burdened between both electrodes as an external circuit, an ion migration occurs in the electrolyte, and the electric energy can be taken out in the external load. Thus, a wide variety of fuel cells are expected to be applied to a large-scale power generation system, a small-sized distributed cogeneration system, an electric vehicle power system and the like, and researches and developments for practical use thereof have been actively developed.

Fuel cells can be classified into polymer electrolyte type, phosphoric acid type, molten carbonate type, solid oxide type, and others, depending on the material of electrolyte membrane or operating temperature, and so on.

Among them, the polymer electrolyte fuel cell (PEFC), in which a polymer electrolyte membrane having proton conductive property represented by poly(perfluorosulfonic acids) ionomer, sulfonated aromatic hydrocarbon-based ionomer, and the like is used, and power generation is performed by oxidizing hydrogen in an anode side and reducing oxygen in a cathode side, is known as a fuel cell which can generate power at a comparatively lower temperature and has a high power density.

In addition, a direct methanol fuel cell (DMFC), in which methanol or an aqueous methanol solution of liquid state is used as a fuel instead of hydrogen, has been attracting attention in recent years. The DMFC is classified into active type (a fuel and air are forcibly supplied), semi-active type (either of fuel or air is forcibly supplied), passive type (fuel and air are naturally supplied), and others, depending on the supplying method of fuel and air.

Power generation in the PEFC or the DMFC is carried out by a membrane-electrode assembly (MEA) which has a constitution in which a polymer electrolyte membrane is interleaved between the anode and the cathode. In a catalyst electrode layer of the anode and the cathode, catalyst metal, an electronic conductor supporting the catalyst metal, and a polymer ionomer having the proton conductive property (proton conductive ionomer) are present in a mixed state. As the catalyst metal, Pt alloy fine particles are widely used, and as the electronic conductor supporting the catalyst metal, carbon particles having a large specific surface area are used.

The proton conductive ionomer in the catalyst electrode layer is also called as a binder, and its role includes bonding the electronic conductors to each other, transferring the proton reacted on the catalyst metal to the electrolyte membrane efficiently, and others.

Since a poly(perfluoroalkylsulfonic acid) polymer has been widely used as the electrolyte membrane used for the PEFC and the DMFC, the poly(perfluoroalkylsulfonic acid) polymer has been also used as a proton conductive ionomer in the catalyst electrode.

When the poly(perfluoroalkylsulfonic acid) polymer is used for the electrolyte membrane and the proton conductive ionomer, adhesive property between membrane-electrode becomes better, and interfacial resistance between membrane-electrode can be reduced.

On the other hand, in recent years, as well as the poly(perfluoroalkylsulfonic acid) polymer is used for the electrolyte membrane, a hydrocarbon-based proton conductive ionomer (hydrocarbon-based ionomer) has been used for the electrolyte membrane.

The electrolyte membrane using the poly(perfluoroalkylsulfonic acid) ionomer is high in production cost, and when methanol is used as the fuel, permeation (cross-over) of methanol from a fuel electrode to an air electrode tends to occur, and a decrease in power generation efficiency is concerned.

In order to solve this problem, use of various hydrocarbon-based ionomers for the electrolyte membrane (hydrocarbon-based electrolyte membrane) has been studied (JP-A-09-245818).

Even in this case, the poly(perfluoroalkylsulfonic acid) polymer is frequently used for the proton conductive ionomer in the catalyst electrode. However, the poly(perfluoroalkylsulfonic acid) polymer has a feature that it tends to swell when immersed into the methanol, there is thus room for improvement concerning shape stability as a catalyst electrode layer.

In addition, the adhesive property between the hydrocarbon-based electrolyte membrane and the catalyst electrode layer containing the poly(perfluoroalkylsulfonic acid) polymer is poor, and such a problem has been identified that the catalyst electrode layer and the electrolyte membrane are delaminated during the power generation to increase a resistance component arisen from their interface.

Therefore, it has been studied to use the hydrocarbon-based ionomer for a binder (JP-A-2005-197071). Further, a technology, in which a proton conductive ionomer and a proton insulating styrene-based thermoplastic elastomer ionomer are mixed to improve the adhesive property, has been disclosed (JP-A-2006-286521).

JP-A-2006-269133 discloses a MEA comprising an electrolyte membrane and a pair of catalyst layers interleaving the electrolyte membrane, characterized in that a polymer electrolyte contained in the electrolyte membrane and the catalyst layer comprise an inorganic oxide and a metal having H₂O₂-decomposing ability and/or a metal oxide having H₂O₂-decomposing ability.

### SUMMARY OF THE INVENTION

The catalyst electrode layer (also referred to as electrode catalyst layer) using the hydrocarbon-based ionomer as a binder, which has been reported until now, is superior in its shape stability and adhesive property to the hydrocarbon-based electrolyte membrane. However, there is room for improvement in the point that its initial cell performance is low compared with the layer containing poly(perfluoroalkylsulfonic acid) ionomer as a binder.

An object of the present invention is to provide a membrane-electrode assembly for a fuel cell which exhibits a high catalyst utilization and the gas diffusivity by suppressing excessive penetration of the binder ionomer into pores of carbon supports, as well as a method for producing the same.

The membrane-electrode assembly according to the present invention comprises an anode, a cathode and a polymer electrolyte membrane and has a constitution in which the polymer electrolyte membrane is interleaved between the anode and the cathode, and is characterized in that the anode and the cathode contain an agglomerate structure of carbon support formed with a plurality of carbon primary particles supporting catalyst particles, and particulate media having a polymer electrolyte on the surface thereof is contained between adjacent the agglomerate structures of carbon support.

According to the present invention, the catalyst utilization in anode and cathode can be increased as well as the gas diffusivity can be improved, and a fuel cell having high output power can be obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic cross-sectional view illustrating the fuel cell of an Example according to the present invention.

FIG. 2 is a pattern configuration diagram illustrating a carbon support used for the membrane-electrode assembly of an Example according to the present invention.

FIG. 3 is a pattern configuration diagram illustrating an electrode catalyst layer of the conventional membrane-electrode assembly.

FIG. 4 is a pattern configuration diagram illustrating an electrode catalyst layer in the membrane-electrode assembly of an Example according to the present invention.

FIG. 5 is a pattern configuration diagram illustrating an electrode catalyst layer in the membrane-electrode assembly of another Example according to the present invention.

FIG. 6 is a pattern configuration diagram illustrating an electrode catalyst layer in the membrane-electrode assembly of another Example according to the present invention.

FIG. 7 is a pattern configuration diagram illustrating an electrode catalyst layer in the membrane-electrode assembly of another Example according to the present invention.

FIG. 8 is a schematic cross-sectional schematic view of a portable information terminal according to the present invention.

### DETAILED DESCRIPTION OF THE EMBODIMENTS

The present invention relates to a fuel cell, in particular, a fuel cell having a catalyst electrode layer coated on the electrolyte membrane.

The present inventor has intensively studied on relationship among cell performance, performance of single electrode, and electrode structure in a MEA using a hydrocarbon-based ionomer and a poly(perfluoroalkylsulfonic acid) polymer as a binder, and obtained the following findings.

It was found that the cell performance is strongly influenced by the catalyst utilization in anode and cathode as well as the diffusivities of fuel and air in the electrode. Further, it was ascertained that, in the catalyst utilization and the gas diffusivity in the electrode, coating degree of the binder ionomer on the surface of carbon support is greatly involved, and as the coating degree of the binder ionomer to the surface of carbon support in the electrode becomes higher, the catalyst utilization and the gas diffusivity tend to become lower, resulting in a lower cell voltage.

In particular, it was confirmed that the hydrocarbon-based ionomer shows a higher wettability to the surface of carbon support, reducing the catalyst utilization and the gas diffusivity.

The above-described correlation between the coating degree of the binder to the surface of carbon support and the electrode performances can be understood as described below.

When the coating degree of binder to the surface of carbon support is high, an exposed area of the carbon support in the electrode decreases. In this case, electron conduction between adjacent carbon particles tends to be easily inhibited by the electron insulating binder ionomer coated on the surface thereof. Consequently, the number of the catalyst particles insulated in the electrode increases, resulting in the lower catalyst utilization.

In addition, when the binder easily covers the surface of the carbon support, a large amount of binder tends to penetrate into pores in the carbon support and fill up the pores. The vacant pores in an electrode act as a gas diffusive path to the surface of catalyst. Therefore, if these pores are filled with the binder, gas diffusion rate in the electrode is considered to decrease.

One means to solve the above-described problem is a decrease in amount of the binder added in an electrode. By this means, the electron conductivity in an electrode is increased, which will enhance the catalyst utilization and the gas diffusivity in an electrode. On the contrary, in this method, since proton conductive paths in the electrode becomes narrow, and actual cell reaction becomes proton-supply-limited one. As a consequence, the surface area of catalyst capable of contributing to the cell reaction even decreases. Furthermore, due to concentration of current to a portion of the catalyst surface capable of contributing to the cell reaction, the gas supply is stagnated, resulting in a suppression of the cell reaction. Therefore, the catalyst utilization and the gas diffusive path should be increased with keeping sufficient proton conductive paths in the electrode.

Hereinafter, a membrane-electrode assembly according to one embodiment of the present invention, and a fuel cell and fuel cell power generation system using the same, as well as a method for producing the membrane-electrode assembly will be explained.

The membrane-electrode assembly comprises an anode, a cathode and a polymer electrolyte membrane and has a constitution in which the polymer electrolyte membrane is interleaved between the anode and the cathode, and the anode and the cathode contains an agglomerate structure of carbon support formed with a plurality of carbon primary particles supporting catalyst particles, and particulate media having polymer electrolytes on the surface thereof is contained between adjacent the agglomerate structures of carbon support.

The membrane-electrode assembly has primary pores between the carbon primary particles constituting the carbon support, and secondary pores between a plurality of the carbon support.

In the membrane-electrode assembly, the particulate media are formed with a polymer electrolyte.

In the membrane-electrode assembly, the particulate media are needle-like or rod-like particles.

In the membrane-electrode assembly, the particulate media are formed by coating the polymer electrolyte on the surface of a particulate medium core.

In the membrane-electrode assembly, the particulate media are polystyrene-based resin particles, metal oxide particles or carbon particles.

In the membrane-electrode assembly, the particulate medium cores are needle-like or rod-like particles.

In the membrane-electrode assembly, an anion-exchange group is covalently bonded on the surface of the particulate medium core, and the surface of the particulate medium core is coated with the polymer electrolyte having a cation-exchange group.

In the membrane-electrode assembly, the particulate media have at least one of peak diameter in the particle size distribution thereof, and the peak diameter is ranged from 40 nm to 1 μm.

In the membrane-electrode assembly, an average particle diameter of the particulate media is larger than an average particle diameter of a plurality of the carbon primary particles supporting the catalyst particle. In the membrane-electrode assembly, the polymer electrolyte contained in at least one of the anode and the cathode is formed with an aromatic hydrocarbon-based electrolyte having a cation-exchange group.

In the membrane-electrode assembly, the polymer electrolyte membrane is formed with the aromatic hydrocarbon-based electrolyte having the cation-exchange group.

The fuel cell uses the above-described membrane-electrode assembly.

The fuel cell power generation system uses the fuel cell.

A method for producing the membrane-electrode assembly is a method for producing a membrane-electrode assembly comprising an anode, a cathode and a polymer electrolyte membrane and having a constitution in which the polymer electrolyte membrane is interleaved between the anode and the cathode, and comprises a step to prepare a particulate media dispersion liquid in which the particulate media having polymer electrolyte on the surface thereof is dispersed in a solvent, a step to prepare a catalyst slurry by mixing carbon particles supporting catalyst particles with the particulate media dispersion liquid, and a step to prepare the anode and the cathode by coating the catalyst slurry on the surface of the polymer electrolyte membrane.

A method for producing the membrane-electrode assembly comprises a step to prepare the particulate media by coating the surface of particulate medium core with the polymer electrolyte.

A method for producing the membrane-electrode assembly comprises an anion-exchange group modification step to modify the surface of the particulate medium core with an anion-exchange group, and a step to prepare the particulate media by mixing the polymer electrolyte having a cation-exchange group.

In the method for producing the membrane-electrode assembly, the anion-exchange group modification step is a step to modify a silanol agent containing the anion-exchange group onto the surface of the particulate medium core.

The membrane-electrode assembly is a membrane-electrode assembly for fuel cells formed by interleaving a polymer electrolyte membrane by an anode comprising a catalyst and a polymer electrolyte and a cathode comprising a catalyst and a polymer electrolyte, wherein particulate agglomerates of the polymer electrolyte are present in at least one of the anode or the cathode, particle size distribution of the agglomerates of the polymer electrolyte has one or more peaks, and L1>L2 is satisfied when L1 represents a particle diameter giving the maximum peak and L2 represents a primary particle size of carbon particles.

In a membrane-electrode assembly having such structure, since the polymer electrolyte in an electrode becomes particulate shape, contact area with carbon particles decreases and electron conductivity among the carbon particles is kept high, which causes the catalyst utilization to increase. Further, since the size of agglomerate of this polymer electrolyte is larger than that of the primary particles of carbon support, the polymer electrolyte does not penetrate into the inside of agglomerate structure of carbon particles. Therefore, the pores in the agglomerate structure are not filled up completely, and a gas diffusive path is secured, and thereby increasing gas diffusivity. In the electrode with such structure, a high volume ratio of polymer electrolyte in the electrode can be maintained, which promotes the formation of sufficient proton conduction paths.

Here, the presence of the polymer electrolyte as particulate agglomerates in the electrode can be confirmed by observing a cross-section of the membrane-electrode assembly using a scanning electron microscope (SEM) or a transmission electron microscope (TEM). In addition, the size of polymer electrolyte agglomerate and the size of carbon primary particle can be also evaluated using the SEM or TEM. Each particle size distribution can be obtained by measuring the sizes of more than 30 particles selected arbitrarily using the SEM or TEM, and preparing a histogram about their sizes and frequencies. It should be noted that, the polymer electrolyte agglomerate is not necessarily spherical, and the particle size thereof varies depending on the direction of axis to be measured. In this case, a diameter of a circle which gives the same area as that of the cross-section of the agglomerate can be set to be particle size.

The membrane-electrode assembly is a membrane-electrode assembly for fuel cells formed by interleaving a polymer electrolyte membrane by an anode comprising catalysts and a polymer electrolyte and a cathode comprising catalysts and a polymer electrolyte, wherein particulate agglomerates of the polymer electrolyte are present in at least one of the anode or the cathode, the particle size distribution of the agglomerates of the polymer electrolyte has one or more peaks and L1 is 40 nm or more when L1 represents a particle diameter giving the maximum peak. In a catalyst suitable to obtain a high cell performance, when the size of pores formed by agglomeration of carbon particles is less than 40 nm and L1 larger than this value, this is effective to suppress the penetration of the polymer electrolyte into the pores and improve the gas diffusivity.

In addition, the membrane-electrode assembly is characterized in that L1 is 40 to 1,000 nm. L1 in this range is desirable, because the solid polymer becomes easy to exist among the carbon aggregates present in large quantity, and the proton conductive paths can be formed effectively without disturbing the gas diffusivity.

In addition, the membrane-electrode assembly includes the one in which needle-like polymer electrolyte agglomerates are present in at least one of anode or cathode, and further the assembly is characterized in that a relationship of L3>L2 is satisfied, provided that L2 represents the primary particle size of the carbon particle and L3 represents an average length in the long axis direction of the needle-like agglomerates. Such constitution is desirable, because the penetration of the needle-like polymer electrolyte into the pores inside of the carbon aggregates is suppressed, and the gas diffusive paths can be easily formed. In addition, such constitution is also desirable, because the electrolyte is mixed as needle-like agglomerates and, as a result, a contact frequency of electrolyte with each other is increased, and proton conductive paths can be easily secured.

Here, the presence of the polymer electrodes in the electrode as needle-like agglomerates can be confirmed by observing a cross-section of the relevant membrane-electrode assembly by the scanning electron microscope (SEM). As for electrolyte agglomerates in a sectional image, it is referred to as needle-like electrolyte agglomerates when lengths along two orthogonal axes of an electrolyte agglomerate are different, and the ratio of the two lengths is 2 or more. L3 can be obtained by setting a long axis for each needle-like agglomerate, measuring the length thereof, and preparing a histogram about the lengths and frequencies.

In addition, when L3 is 40 nm or more, the penetration of the polymer electrolyte into the pores is suppressed, and it is effective to improve the gas diffusivity.

In addition, the electrolyte agglomerate contained in at least one of the anode or the cathode in the membrane-electrode assembly may have a structure, wherein a periphery of particulate or needle-like media in which the particulate or needle-like agglomerates has substantially no cation-exchange group is coated with a polymer ionomer having a cation-exchange group. Such constitution is desirable from the viewpoint of the gas diffusivity, because swelling of electrolyte agglomerate in the electrode due to water absorption can be suppressed, and the pore size distribution in the electrode is not varied.

In addition, the electrolyte agglomerate contained in at least one of the anode or cathode in the membrane-electrode assembly is characterized in that the particulate media coated with the polymer electrolyte is oxide particles comprising a transition metal. Here, the metal element constituting the oxide particle is not particularly limited, but the oxide particle desirably is not dissolved in an acidic zone. The oxide particle is desirable, because it substantially does not swell by water absorption, and further is superior in adhesive property to the polymer electrolyte having a cation-exchange group, and furthermore, it has high moisture-retaining property, and hence proton resistance in the electrode can be reduced.

In addition, the electrolyte agglomerate contained in at least one of the anode or cathode in the membrane-electrode assembly is characterized in that the particulate media coated with the polymer electrolyte is bead particle comprising polystyrene as a main skeleton. Here, the bead particle comprising polystyrene as the main skeleton is the one in which a polystyrene or a polymer having a polystyrene aromatic ring modified with a functional group agglomerates by intra- or inter-molecular interaction, or cross-linking, to form a particulate form.

In addition, the electrolyte agglomerate contained in at least one of the anode or cathode in the membrane-electrode assembly is characterized in that the particulate media coated with the polymer electrolyte is carbon particles not supporting the catalyst particles.

In addition, when the above-described particulate media are coated with the polymer electrolyte, it is particularly effective to bind both materials by electrostatic interaction.

That is, the membrane-electrode assembly is characterized in that the whole or the surface of the particulate medium is modified with the anion-exchange group, and the polymer electrolyte contains the cation-exchange group. In such constitution, the electrode structure of the present invention can be easily obtained, because the electrostatic interaction is generated between the anion-exchange group on the surface of particulate medium and the cation-exchange group of the polymer electrolyte, and hence the adhesive property at the interface of both materials is enhanced. The anion-exchange group includes an amino group or the like.

The electrolyte agglomerate of the membrane-electrode assembly is characterized by comprising the aromatic hydrocarbon-based electrolyte having the cation-exchange group. When hydrocarbon-based polymer having the aromatic ring is used as a main skeleton, an interaction is generated among the aromatic rings of adjacent polymers, and the binding ability among the electrolyte is increased. Therefore, the binding ability at the contact point of the particulate or needle-like electrolyte is increased, and hence the continuity of the proton conductive path can be easily secured.

In the membrane-electrode assembly, it is desirable that the polymer electrolyte in the electrode is a hydrocarbon-based electrolyte not containing fluorine, because the binding force between the electrolyte and carbon support is increased, and hence the mechanical properties of the electrode are enhanced. This electrolyte contains the cation-exchange group to transmit the proton generated in the anode. The cation-exchange group includes a sulfonic acid group, a phosphate group, a carboxyl group, and the like, and the sulfonic acid group having a high degree of dissociation is particularly desirable.

In addition, in the membrane-electrode assembly, it is desirable that the electrolyte membrane interleaved by the anode and the cathode is the aromatic hydrocarbon-based electrolyte having the cation-exchange group, because a cross-leak of fuel and air in the fuel cell reaction is suppressed. In addition, when the polymer electrolyte in the anode and the cathode is the hydrocarbon-based electrolyte, it is particularly desirable because the adhesive property between the electrode and the membrane is increased.

Among the membrane-electrode assemblies, the one having a structure in which the polymer electrolyte is coated with the particulate or needle-like media not having the cation-exchange group can be produced through the following steps.

That is, the production process comprises: 1) a step to coat a polymer electrolyte on the surfaces of fine particle media by mixing the fine particle media and the polymer electrolyte in an appropriate solvent; 2) a step to obtain the fine particle media coated with the polymer electrolyte by drying and removing the solvent; 3) a step to obtain a catalyst slurry by mixing the fine particle media coated with the polymer electrolyte and the carbon support in an appropriate solvent; and 4) a step to obtain an electrode catalyst layer by coating the catalyst slurry on a base material and drying it.

In the method for producing the membrane-electrode assembly, the catalyst slurry can be also obtained by skipping the above step 2) and mixing the dispersion liquid containing the fine particle produced in the above step 1) with the carbon support.

Further, in the method for producing the membrane-electrode assembly, the polymer electrolyte can be coated on the periphery of the particles by modifying the whole or the surface of the fine particle media with the anion-exchange group and mixing this fine particle media with the polymer electrolyte having the cation-exchange group. This case is desirable, because electrostatic interaction is generated between the anion-exchange group and the cation-exchange group at the interface of the particulate media and the polymer electrolyte fine particle media, and hence the adhesion between both materials can be increased.

A fuel cell constructed using the membrane-electrode assembly as a power generation section, and using a gas diffusive layer, a member to supply air (oxygen), and a member for power collection, can be a fuel cell having high output power, because suitable proton conductive paths and gas diffusive paths are formed in the electrode. Here, the member to supply a fuel means a set of members to supply the fuel introduced by a pump or the like to the gas diffusive layer through a separator, and the member to supply the air (oxygen) means a set of members to supply the air (oxygen) introduced by a blower or the like to the diffusive layer through the separator. It should be noted that, as the fuel, an aqueous methanol solution or a hydrogen gas is used.

As mentioned above, according to the embodiments of the present invention, by suppressing the penetration of the polymer electrolyte into the pores of the carbon particles in the electrode and securing the proton conductive paths, the gas diffusive paths, and the electron conductive paths in an electrode, the structure of the membrane-electrode assembly having low electrode overpotential, constituent materials thereof, the method for producing the assembly, and the fuel cell using the assembly are provided.

Hereinafter, Examples of the present invention will be explained referring to the drawings.

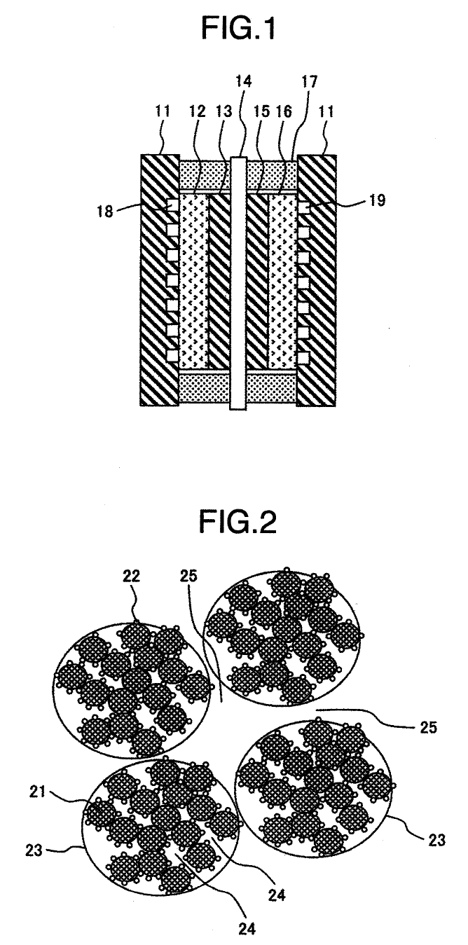

FIG. 1 illustrates one Example of the cell constitution of the fuel cell using the membrane-electrode assembly of the present invention.

Each of the symbols in FIG. 1 indicates as follow: 11 a separator, 13 an anode catalyst layer, 12 an anode diffusive layer, 14 a polymer electrolyte membrane having proton conductivity, 15 a cathode catalyst layer, 16 a cathode diffusive layer, 17 a gasket, 18 a fuel supplying section, and 19 an air supplying section.

The separator 11 has electron conductivity, and as a material thereof, a dense graphite plate, a carbon plate, made by molding carbon materials such as graphite and carbon black and the like by a resin, a metal such as stainless steel, titanium and the like, or the one in which they are coated with a conductive coating material superior in corrosion resistance and heat resistance or a noble metal plating, are desirably used.

An assembly which has been integrated by interleaving the polymer electrolyte membrane 14 between the anode catalyst layer 13 and the cathode catalyst layer 15 is referred to as membrane-electrode assembly.

In the present Example, the assembly has a constitution in which the anode gas diffusion layer 12 and the anode catalyst layer 13 are laminated and the cathode gas diffusion layer 16 and the cathode catalyst layer 15 are laminated, but the assembly is not limited thereto. The assembly may have a constitution in which the anode gas diffusion layer 12 and the anode catalyst layer 13 as well as the cathode gas diffusion layer 16 and the cathode catalyst layer 15 are integrated to one layer, respectively.

As the catalyst to be used in the anode and the cathode, the one having a structure is used in which metal particles facilitating the oxidation reaction for the fuel and the reduction reaction for the oxygen are supported on an electronic conductor having a great specific surface area. As the electronic conductor, carbon black is used.

Each of the fuel supplying section 18 and the air supplying section 19 is a groove provided on the anode side and the cathode side of the separator 11, respectively. To the fuel supplying section 18, the hydrogen, methanol, and the like is supplied as the fuel from a fuel container installed outside the fuel cell. On the other hand, to the air supplying section 19, the air, oxygen and the like is supplied.

FIG. 2 is a pattern configuration diagram illustrating a carbon support using the membrane-electrode assembly of an Example according to the present invention.

The carbon support has a structure in which a catalyst metal particle 22 (also referred to as catalyst particle) is supported on a carbon primary particle 21 (carbon black) of 20 to 40 nm.

A plurality of carbon supports agglutinate to form an agglomerate structure of carbon support 23. Pores formed among the plurality of carbon supports in this agglomerate structure of carbon support 23, that is, pores formed in the agglomerate structure of carbon support 23 are primary pores 24, and pore size thereof is 40 nm or less.

Most of the catalyst metal particles 22 adhere to the internal surface of the primary pore 24, that is, the outer surface of the carbon primary particle 21. In addition, among the plurality of agglomerate structures of carbon support 23, secondary pores 25 of 40 nm to 1,000 nm (1 μm) are formed.

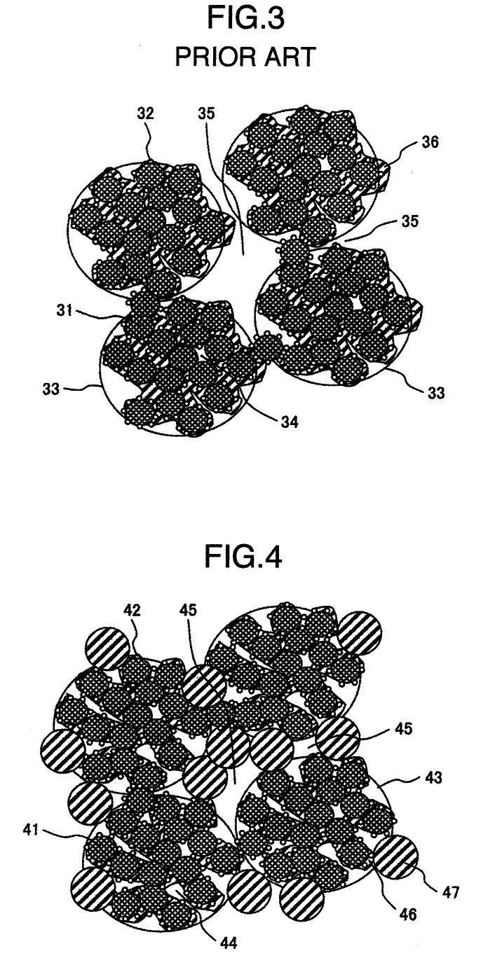

Next, the electrode catalyst layer (anode catalyst electrode layer or cathode catalyst electrode layer) formed by mixing the carbon support illustrated in FIG. 2 and the polymer electrolyte (hereinafter, referred to as electrolyte binder) having proton conductivity will be explained referring to FIG. 3 to FIG. 6.

FIG. 3 is a pattern configuration diagram illustrating a fine structure of the conventional electrode catalyst layer.

This electrode catalyst layer can be obtained by coating a mixture of the carbon support and a solution of the electrolyte binder and drying.

In this drawing, an agglomerate structure of carbon support 33 is formed by the agglomeration of the carbon supports having a structure in which catalyst metal particles 32 are supported on a carbon primary particle 31 (carbon black) of 20 to 40 nm. On the outer surface and inside of this agglomerate structure of the carbon support 33, an electrolyte binder 36 adheres to facilitate the bonding of the agglomerate structures of carbon support 33 to each other. Primary pores 34 are formed inside of the agglomerate structure of carbon support 33, and secondary pores 35 are formed among the plurality of agglomerate structures of carbon support 33.

The electrolyte binder 36 dissolved in a solvent can easily penetrate into the pores in the agglomerate structure of carbon support 33 together with the solvent, and easily moisten and spread on the carbon surface. In this case, the electrolyte binder 36 penetrates more easily into the primary pore 34 having a smaller diameter in comparison with the secondary pore 35 due to capillary phenomena, and hence the primary pore 34 is more easily filled up with the electrolyte binder 36.

For this reason, the electron conductivity among the agglomerate structures of carbon support 33 tends to be inhibited by the electrolyte binder 36 moistened and spread on the surface of the carbon primary particle 31. Further, the diffusion and migration of gas is inhibited by the electrolyte binder 36 penetrated into the primary pore 34.

As a technique to solve this, reduction of the amount of the electrolyte binder 36 itself to be mixed with the carbon support is effective. However, this technique is not desirable, because the amount of electrolyte binder 36 present in the secondary pore 35 is also reduced, and the proton conductivity in the electrode easily decreases.

FIGS. 4 to 7 illustrate the electrode catalyst layer in the membrane-electrode assembly of an Example according to the present invention.

In FIG. 4, an agglomerate structure of carbon support 43 is formed by the agglomeration of the carbon supports having a structure in which a catalyst metal particle 42 is supported on a carbon primary particle 41 (carbon black) of 20 to 40 nm. Primary pores 44 are formed in the agglomerate structure of carbon support 43, and secondary pores 45 are formed among a plurality of the agglomerate structures of carbon support 43. And a particulate polymer electrolyte 47 (particulate medium) constituted by a polymer electrolyte adheres between adjacent agglomerate structures of carbon support 43. These particulate media tend to aggregate preferentially to the secondary pores 45, because the particulate media are larger than the primary pore 44 of the agglomerate structure of carbon support 43.

For this reason, as well as the proton conductive paths in the inner part of the electrode catalyst layer can be secured, a usage of an electrolyte binder 46 can be reduced and the amount of the electrolyte binder 46 penetrating into the primary pore 44 of the agglomerate structure of carbon support 43 can be reduced.

In addition, since this particulate medium has a small contact area with the agglomerate structure of carbon support 43, the electron conductivity among the agglomerate structure of carbon support 43 can be maintained at a high level. As a result, an electrode catalyst layer which has high catalyst utilization and is superior in gas diffusivity can be obtained.

The particle size of the particulate polymer electrolyte 47 in FIG. 4 is desirably 40 nm or more from the viewpoint of the catalyst utilization and the gas diffusivity. Furthermore, the particle size is desirably 40 nm to 1000 nm, more desirably 40 nm to 500 nm, to congregate in the secondary pores to form good proton conductive paths.

A distribution exists in the particle size of the particulate polymer electrolyte 47 in the practical electrode catalyst layer. When mean geometric lengths in short axis and long axis directions are measured for a plurality of the particulate polymer electrolytes 47 to prepare a histogram of the mean geometric size, it is desirable that the particle size having the highest frequency falls in the above-described range.

The catalyst metal particle 42 to be used for the anode and the cathode of this Example may be any metal so long as the metal can facilitate the oxidation reaction of the fuel and the reduction reaction of the oxygen, and the metal includes, for example, platinum, gold, silver, palladium, iridium, rhodium, ruthenium, iron, cobalt, nickel, chromium, tungsten, manganese, vanadium, titanium, or an alloy thereof.

Among the above-described metals constituting the catalyst metal particle 42, platinum (Pt) is used for the cathode, and platinum/ruthenium (Pt/Ru) alloy is used for the catalyst for the anode electrode. The particle size of catalyst metal particle 42 is usually 2 to 30 nm.

The carbon primary particle 41 supporting the catalyst metal particle 42 desirably has a large specific surface area. A finer catalyst metal particle 42 has a higher activity per unit weight due to an increased specific surface area. By supporting on the carbon primary particle 41, the catalyst metal particle 42 can be maintained as a fine particle without agglomerating.

The specific surface area of the carbon primary particle 41 is desirably selected from a range of 10 to 1000 m²/g. Too small specific surface area reduces the effect of adding the carbon primary particle 41, and too large specific surface area increases the number of pores to be formed on the surface of the carbon primary particle 4 allowing the catalyst metal particles 42 to enter into these pores. The catalyst metal particles 42 entered into the pores become difficult to contribute to the reaction when the cell is operated.

As the carbon primary particle 41, for example, carbon black such as Ketjenblack, furnaceblack, channel black, acetylene black, and the like, fibrous carbon such as carbon nanotube or the like, or activated charcoal, graphite, and the like can be used, and these materials can be used alone or in a mixed state thereof.

Among the above materials, Ketjenblack having a large specific surface area is desirably used to increase the activity of the catalyst electrode layer.

As the polymer electrolyte to be used for particulate polymer electrolyte 47 illustrated in FIG. 4, an acidic hydrogen ion conductive material is preferably used, because a stable fuel cell can be realized without being influenced by a carbon dioxide gas in the atmosphere. As an example of such material, poly(perfluoroalkylsulfonic acid) electrolyte and a hydrocarbon-based electrolyte having a polar group showing proton conductivity can be included. In particular, the hydrocarbon-based electrolyte having the aromatic ring is desirably used, because the electrolyte has a superior binding ability among polymers due to the effect of π-electron interaction. The polar group showing the proton conductivity includes the sulfonic acid group, the phosphate group, the carboxyl group, and the like, and the sulfonic acid group is particularly desirable from the viewpoint of the proton conductivity.

As the hydrocarbon-based electrolyte, for example, sulfonated engineering plastic-based electrolyte such as sulfonated polyether ether ketone, sulfonated polyethersulfone, sulfonated acrylonitrile-butadiene-styrene, sulfonated polysulfide, sulfonated polyphenylene, and the like; and alkylsulfonated engineering plastic-based electrolyte such as alkylsulfonated polyether ether ketone, alkylsulfonated polyethersulfone, alkylsulfonated polyether ether sulfone, alkylsulfonated polysulfone, alkylsulfonated polysulfide, alkylsulfonated polyphenylene, alkylsulfonated polyether ether sulfone, and the like, can be used.

Methods for introducing the particulate polymer electrode 47 into the electrode catalyst layer includes a method in which a synthesized and dried electrolyte powder is pulverized using a ball mill equipment or the like, only particles having a desired size are separated using a sieve, and these particles are mixed with the agglomerate structure of carbon support 43.

Alternatively, it is also possible that the electrolyte is dissolved in a good solvent to prepare a varnish to which a poor solvent is added to precipitate the electrolyte in particulate state in the varnish, and then, particles having a desired size are selected from the precipitate using centrifugal separation, filtration, or the like, and these particles are used. Here, the solvent to be used as the good solvent or the poor solvent is not particularly limited so long as the solvent does not give poisoning to the catalyst after washing. For example, besides water, alkylene glycol monoalkyl ether such as ethylene glycol monomethyl ether, ethylene glycol monoethyl ether, propylene glycol monomethyl ether, propylene glycol monomethyl ether, and the like; alcohol such as n-propanol, iso-propanol, t-butyl alcohol, and the like; and a highly polar solvent such as 1-methyl-2-pyrroridone, and the like can be used. Two or more kinds of these solvents can be used in a mixed state. The kind of the good solvent or the poor solvent may vary depending on the electrolyte material.

In addition, by dropping a solution containing metal cation to a varnish in which an electrolyte is dissolved in a good solvent, the electrolyte can be precipitated in particulate state in the varnish by the salting-out effect, and this electrolyte can be used. Such cation is not particularly limited so long as the cation can be ion-exchanged by the proton during washing with an acidic aqueous solution.

In addition, as the particulate polymer electrolyte 47 in FIG. 4, the one in which intra-molecular bonding is increased by subjecting the hydrocarbon-based electrolyte to a cross-linking reaction, or polystyrene beads introduced with a sulfonic acid group, and the like can be used.

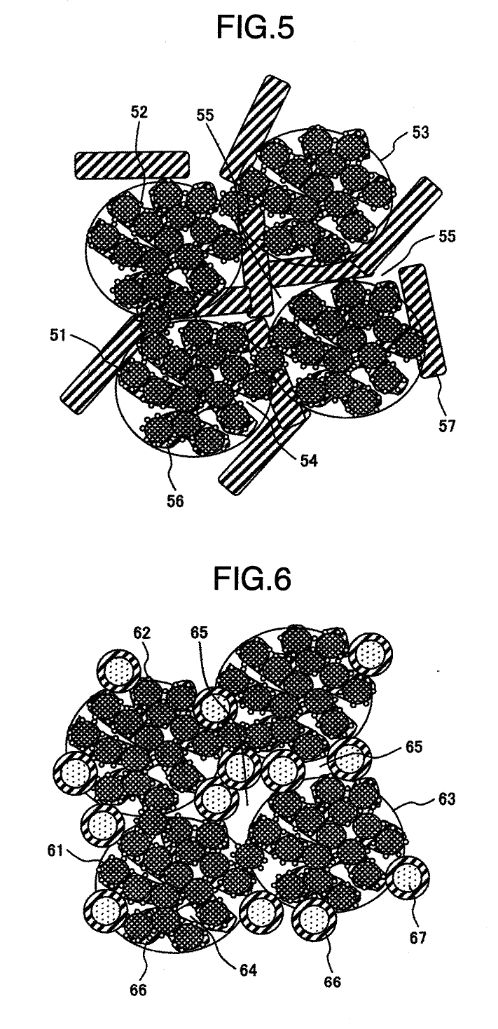

FIG. 5 illustrates an example of the particulate electrolyte binder having a needle-like or a rod-like shape.

In this drawing, the carbon supports having a structure in which a catalyst metal particle 52 is supported on a carbon primary particle 51 (carbon black) of 20 to 40 nm congregate to form an agglomerate structure of carbon support 53. Primary pores 54 are formed inside the agglomerate structure of carbon support 53, and secondary pores 55 are formed among a plurality of the agglomerate structures of carbon support 53. And a particulate polymer electrolyte 57 (particulate medium) constituted with polymer electrolyte adheres between adjacent agglomerate structures of carbon support 53. Since the particulate polymer electrolyte 57 is needle-like or rod-like, filling of the primary pores 54 inside the agglomerate structure of carbon support 53 with the electrolyte can be suppressed, and further the particulate polymer electrolyte 57 prevents agglutination of the carbon primary particle 51 with each other. Hence, a hole volume (pore volume) inside the electrode catalyst layer becomes large and the gas diffusivity is improved. Furthermore, by making particulate the polymer electrolyte 57 needle-like or rod-like, the contact frequency of particulate polymer electrolyte 57 with each other can be increased, and the proton conductive network can be highly formed.

For this reason, as well as the proton conductive path in the electrode catalyst layer can be secured, the usage of electrolyte binder 56 can be reduced, and the amount of the electrolyte binder 56 to penetrate into the primary pore 54 of the agglomerate structure of carbon support 53 can be reduced.

The above-described polymer electrolyte can be used for the particulate polymer electrolyte 57 illustrated in FIG. 5. Methods for making the particulate polymer electrolyte 57 needle-like or rod-like include an electric field spinning method or others.

In FIG. 6, particulate media in which the particulate medium core 67 are coated with an electrolyte binder 66 (polymer electrolyte) are dispersed in the electrode catalyst layer. Here, the particulate medium core 67 is formed with a metal oxide particle, a resin particle of such as polystyrene and the like, a carbon particle, and the like.

In addition, in this drawing, the carbon supports having a structure in which catalyst metal particles 62 are supported on a carbon primary particle 61 (carbon black) of 20 to 40 nm congregate to form an agglomerate structure of carbon support 63. Primary pores 64 are formed inside the agglomerate structure of carbon support 63, and secondary pores 65 are formed among a plurality of the agglomerate structures of carbon support 63.

In a structure in which the average particle size of the particulate medium core 67 is larger than the primary pore 64 of the agglomerate structures of carbon support 63, the particulate medium core 67 tends to congregate preferentially to the secondary pore 65. For this reason, as well as proton the conductive path in the electrode catalyst layer can be secured, the amount of the electrolyte binder 66 to penetrate into the primary pore 64 of the agglomerate structures of carbon support 63 to be used can be reduced similarly to the case in FIG. 4.

In addition, since the electrolyte binder 66 (polymer electrolyte) coated on the particulate medium core 67 has a small contact area with the agglomerate structure of carbon support 63, the electron conductivity among the agglomerate structures of carbon support 63 can be maintained at high level. As a result, an electrode catalyst layer having a high catalyst utilization and superior in the gas diffusivity can be provided.

Further, by using a substance having a low swelling ratio to water as the particulate medium core 67 coated with the electrolyte binder 66, volume expansion of the particulate medium core 67 during the power generation of fuel cell can be suppressed. For this reason, a pore volume inside the electrode catalyst layer can be secured, and an electrode catalyst layer superior in the gas diffusivity can be obtained.

For the electrolyte binder 66 in FIG. 6, the same polymer electrolyte as described above is desirably used.

In addition, as the particulate medium core 67 coated with the electrolyte binder 66 in FIG. 6, a material having a low swelling ratio to water or a material superior in acid resistance and oxidation resistance is desirable, and further a material the particle size of which can be controlled within a range from 10 nm to 1 μm is desirable.

Transition metal oxide is desirable as the particulate medium core 67, because the particle size of the oxide can be controlled depending on the preparation procedures thereof. Specifically, oxide particles of transition metal such as Ti, Nb, Zr, Mn, Cr, Co, Cu, Ce, Rb, Co, Ir, Ag, Rh, Al and Sb, or Si, can be used. In particular, oxide particles having a small dissolution coefficient to an acidic aqueous solution is desirable. An example thereof includes TiO₂, ZrO₂, and SiO₂.

In addition, as the particulate medium core 67, polystyrene beads having an intra-molecular cross-linking structure can also be used. The surface of the polystyrene beads can be modified with the amino group, carboxyl group, sulfonic acid group, or others. In particular, the modification of the surface of the particulate medium core 67 with amino group is desirable, because the particulate medium core 67 acts as polycation, and due to its electrostatic interaction, adhesive property to the polymer electrolyte of a polyanion is increased.

Further, as the particulate medium core 67 in FIG. 6, a carbon material not supporting the catalyst can be also used. The carbon material to be used is desirably selected from the range of 10 to 1000 m²/g similarly to the carbon primary particle 61. For example, the carbon material includes the carbon black such as, for example, Ketjenblack, furnaceblack, channel black, acetylene black, and the like.

In addition, use of a fibrous carbon such as carbon nanotube and the like is desirable, because the shape of the one in which the fibrous carbon is coated with the electrolyte binder 66 becomes needle-like or rod-like, i.e. the same shape as in FIG. 5.

The surface state of the carbon material to be used here is not particularly limited, but the one in which the surface has been oxidized by the sulfuric acid or an aqueous hydrogen peroxide solution to increase its hydrophilic property can be used.

When the electrolyte binder 66 is coated on the spherical, needle-like or rod-like particulate medium core 67, as in FIG. 6, the surface of the medium can be modified with the anion-exchange group by applying a suitable surface treatment. Since the anion-exchange group on the surface and the cation-exchange group contained in the electrolyte binder 66 to be coated attract each other due to the electrostatic interaction, the adhesive property between the electrolyte binder 66 and the particulate medium core 67 can be increased. The anion-exchange group includes the amino group and others.

The method for modifying the surface of the above-described transition metal oxide or the carbon material with the anion-exchange group is not particularly limited, so long as covalent bond can be provided between the anion group or a molecular chain containing the anion group, and the above-described transition metal oxide or the carbon material.

As one method, such a method is included that a hydroxyl group present on the surface of the transition metal oxide or carbon material is modified with a silane coupling agent by mixing the silane coupling agent having an anion-exchange group at the terminal (NH₂—(CH)ₘ—Si(—X)ₙ (here, m and n represent integers, X represents OH, O—(CH₃), or the like)) and the above-described transition metal oxide or carbon material, and subjecting them to a heat treatment. The silane coupling agent includes 3-aminopropyltriethoxysilane and the like.

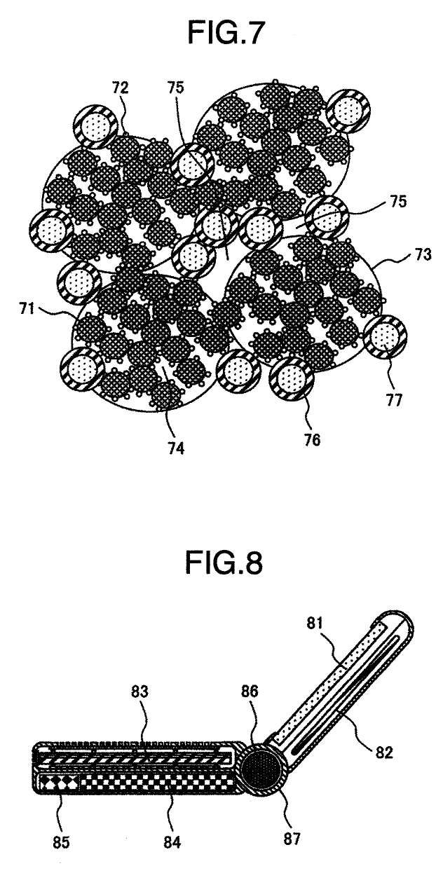

FIG. 7 illustrates an Example in which the electrolyte binder adhering to the primary pores and others of the agglomerate structure of carbon support has been reduced as much as possible.

In this drawing, particulate medium cores 77 coated with an electrolyte binder 76 (polymer electrolyte) are dispersed in the electrode catalyst layer. In addition, the carbon supports having a structure in which catalyst metal particles 72 are supported on a carbon primary particle 71 (carbon black) of 20 to 40 nm congregate to form an agglomerate structure of carbon support 73. Primary pores 74 are formed inside the agglomerate structure of carbon support 73, and secondary pores 75 are formed among a plurality of the agglomerate structures of carbon support 73. Hereinafter, an electrolyte binder 76 and a particulate medium core 77 is sometimes referred to as particulate media as a whole.

In a structure in which the average particle size of the particulate medium core 77 is larger than the primary pore 74 of the agglomerate structures of carbon support 73, the particulate medium core 77 tends to congregate preferentially to the secondary pore 75. Therefore, as well as the proton conductive path in the electrode catalyst layer can be secured, the usage of the electrolyte binder 76 to penetrate into the primary pore 74 of the agglomerate structures of carbon support 73 can be reduced drastically.

In addition, in the preparation process of the electrode of the present invention, besides the electrolyte binder 76 (polymer electrolyte) coating the surface of the particulate medium core 77, a non-particulate (amorphous) polymer electrolyte (may be referred to as non-particulate electrolyte or amorphous electrolyte) can be added. This non-particulate electrolyte has an action to improve the adhesive property among the particulate media or between the particulate media and the carbon support. The non-particulate electrolyte may be the same to or different from the polymer electrolyte present on the surface of the particulate medium.

In addition, in the preparation process of the electrode of the present invention, after obtaining the particulate or needle-like media having the electrolyte on the surface thereof, intra-molecular or inter-molecular cross-linking reaction in the electrolyte may be progressed. By progressing the cross-linking reaction in such way, as well as dissolution resistance of the electrolyte can be increased, swelling thereof can be suppressed. Methods to progress the cross-linking reaction of the electrolyte includes a method in which the particulate or needle-like media having the aromatic hydrocarbon-based electrolyte on the surface thereof is added to a mixed solution of a methanesulfonic acid and a pentoxide diphosphorus, and subjected to a heat treatment at 80° C. or higher, to form an inter-molecular cross-link through sulfonic acid groups.

The membrane-electrode assembly of an Example according to the present invention can be formed by interleaving a polymer electrolyte membrane showing proton conductive property with the electrode catalyst layer having the structure shown in FIGS. 4 to 7. Here, the material to be used for the polymer electrolyte membrane includes the above-described polymer electrolyte.

It can be verified whether the prepared membrane-electrode assembly practically satisfy the constituent features of the present invention, by observing a cross-section of the resultant membrane-electrode assembly by a scanning-type electron micrometer (SEM). It can be judged from a cross-sectional SEM image whether the particulate, needle-like or rod-like electrolyte binder or the particulate media are present inside the electrode catalyst layer. In addition, it becomes possible to judge whether the observed agglomerate is the electrolyte or not, by carrying out mapping of the composition using an energy dispersive X-ray spectrometer (EDX) attached to the SEM.

In addition, it can be judged whether the electrode catalyst layer contains a particle having a structure in which the surface of the particular, needle-like or rod-like particulate media are coated with the polymer electrolyte as illustrated in FIGS. 6 and 7, by observing a cross-sectional slice image of the membrane-electrode assembly by a transmission electron microscope (TEM), and carrying out mapping of elements of such particle.

In addition, for estimating the degree of filling in the pores (primary pores and secondary pores) of the agglomerate structure of carbon supporting catalyst (agglomerate structure of carbon support) with the electrode electrolyte (electrolyte binder) inside the anode and the cathode, pore size distribution of the prepared electrode catalyst layer can be evaluated by using a mercury intrusion technique. The degree of filling can be obtained by comparing the data of electrode catalyst layers with that of carbon supporting catalysts without any binder.

In the present Example, the catalyst utilization and the gas diffusivity inside the electrode catalyst layer can be improved by making the polymer electrolyte contained in the cathode and anode (electrode catalyst layer) particulate needle-like or rod-like, making the size thereof larger than the primary pore of the agglomerate structure of carbon support, and thus preventing the catalyst metal particle adhering to the inner surface of the primary pores from being filled with the polymer electrolyte. As a result, the cell voltage of the fuel cell with the membrane-electrode assembly can be increased.

Hereinafter, the materials applied to the membrane-electrode assembly of the present invention will be explained using Examples, however, the scope of the present invention is not limited to Examples shown here.

### (Preparation of a Pt/C Slurry for PEFC Anode)

Platinum catalysts supported on Ketjenblack with a loading ratio of 67 weight %, and Nafion (R) were added to a solvent mixture mainly composed of propanol, where the weight ratio of catalysts and Nafion (R) was 1:0.2. The mixture was stirred for 12 hours using a magnetic stirrer to prepare a Pt/C catalyst slurry for anode.

Anode binder in all Examples described below was Nafion (R) in order to compare the cathode performances of them.

### (Preparation of PEFC Electrolyte Membrane)

An alkylsulfonated polyethersulfone polymer (hereinafter, referred to as Polymer

A) was synthesized. The Polymer A had a number average molecular weight of 90000 and an ion exchange capacity (IEC) of 1.4 mmol/g. The Polymer A was dissolved in 1-methyl-2-pyrroridone to obtain a solution of 25% by weight. The solution was filtered and coated on a base material, then dried to obtain an electrolyte membrane A of 50 μm.

### PREPARATION OF COMPARATIVE EXAMPLE 1

Alkylsulfonated polyethersulfone (hereinafter, referred to as Polymer B) was synthesized. The Polymer B had a number average molecular weight of 100700 and an IEC value of 1.7 mmol/g.

(1-2)

The Polymer B (10 g) dried at 120° C. for 2 hours was taken out, and an ethylene glycol monomethyl ether (90 g) was dropped thereto to obtain a Polymer B solution of 10% by weight. A radius of gyration of the polymer in this solution was evaluated using a pulsed-field-gradient nuclear magnetic resonance spectroscopy (PFG-NMR), and found to be 25 nm.

(1-3)

The Ketjenblack supporting 67% of platinum by weight (produced by Tanaka Kikinzoku Kogyo K. K., TEC10E70TPM) was mixed with a solvent mixture containing the ethylene glycol monomethyl ether as a main component. To this mixture, the Polymer B solution obtained in the above (1-2) was added so that a weight ratio of the catalyst to Polymer B became 1:0.8. The mixture was stirred using a magnetic stirrer for 12 hours to obtain a Pt/C catalyst Slurry A for cathode.

(1-4)

The Pt/C slurry for anode was coated on one surface of the electrolyte membrane A using a spray coater, to obtain an anode. In addition, the catalyst Slurry A obtained in the above-described (1-3) was coated on another surface of electrolyte membrane A, to obtain a cathode. The sample after coating the electrodes was subjected to thermocompression bonding by a hot press to prepare a membrane-electrode assembly. The hot press temperature was 120° C. and the compression pressure was 80 kg/cm². The membrane-electrode assembly after press was washed with a 1M aqueous sulfuric acid solution, rinsed with ultrapure water, and dried.

(1-5)

From the membrane-electrode assembly prepared in the above-described (1-4), a cross-sectional slicing was carried out using a freezing microtome, and existence states of the carbon support and Polymer B in the electrode were ascertained using a SEM. It was ascertained that the size of the carbon primary particle is 30 nm and that Polymer B introduced as an electrode electrolyte is coating the carbon support surface uniformly. In addition, an electrode slice prepared using the freezing microtome was observed using a TEM, and it was ascertained that Polymer B is coating the carbon support surface in a thickness of about 5 to 10 nm.

(1-6)

In addition, Slurry A for the cathode obtained in the above-described (1-3) was spray-coated onto a polyimide sheet, and dried. Pore size distribution of this dried one was evaluated using the mercury intrusion technique, and compared with the pore size distribution of the Pt/C catalyst alone. In the Pt/C catalyst alone which was not mixed with the electrode electrolyte, pores having a diameter of 10 to 40 nm corresponding to voids in the agglomerate structure of carbon support were clearly observed. These pores are considered to be the primary pores. By introducing the Polymer B, these pores having a diameter of 10 to 40 nm significantly decreased to a 30% of the pores before introducing Polymer B. This means that Polymer B as an electrolyte is filling up 70% of the primary pores.

### PREPARATION OF EXAMPLE 1

(2-1)

The Polymer B synthesized in the above-described (1-1) was dried at 120° C. for 2 hours. This Polymer B (10 g) was taken out, and a mixture (90 g) of 1-propanol, 2-propaol and water in a weight ratio of 40:40:20 was dropped thereto. A sample bottle containing this mixture was placed in a water bath equipped with an ultrasonic generator, and irradiated with an ultrasonic wave to the disperse Polymer B.

Although the mixture of 1-propanol, 2-propaol and water was used as a solvent in this Example, a mixture further containing 1-methyl-2-pyrroridone may be used as the solvent.

(2-2)

To the dispersion liquid of Polymer B prepared in the above-described (2-1), a 0.2 M aqueous sodium hydroxide solution was added and neutralized the pH of the dispersion liquid, and then dispersed particles of Polymer B was formed in the liquid. This liquid was referred to as dispersion liquid B. The size of the dispersed particles in dispersion liquid B was measured using a dynamic light scattering measuring equipment (manufactured by Otsuka Electronics Co., Ltd., ELS 8000), and a peak of distribution was ascertained to be in a range of 1000 to 1200 nm.

(2-3)

To a solvent mixture containing mixed solvents of 1-propanol, 2-propaol and water (weight ratio=40:40:20) as a main component, the Ketjenblack supporting 67% of platinum by weight (produced by Tanaka Kikinzoku Kogyo K. K., TEC10E70TPM) and the dispersion liquid B prepared in the above-described (2-2) were added in a weight ratio of 1:0.18. The mixture was stirred using a magnetic stirrer for 12 hours to obtain Slurry B for the cathode.

(2-4)

The Pt/C slurry for anode was coated on one surface of the electrolyte membrane A using a spray coater, to obtain an anode. In addition, the catalyst slurry B obtained in the above-described (2-3) was coated on another surface of the electrolyte membrane A, to obtain a cathode. The sample after coating the electrodes was subjected to thermocompression bonding by a hot press to prepare a membrane-electrode assembly. The hot press temperature was 120° C. and the compression pressure was 80 kg/cm². The membrane-electrode assembly after press was washed with a 1M aqueous sulfuric acid solution, rinsed with ultrapure water, and dried.

(2-5)

From the membrane-electrode assembly prepared in the above-described (2-4), a cross-sectional slicing was carried out using the freezing microtome, and existence states of the carbon support and Polymer B in the cathode electrode were confirmed using a SEM. Particulate agglomerates of 500 to 2000 nm were confirmed in the electrode, and a highest frequency particle size was found to be 1100 nm from the histogram. Elements of this agglomerate were analyzed using an EDX, and C, O and S were detected in higher contents, and it was ascertained that the electrode electrolyte contains the sufonic acid group.

(2-6)

In addition, Slurry B for the cathode obtained in the above-described (2-3) was spray-coated on a polyimide sheet. Pore size distribution of this coated one was evaluated using the mercury intrusion technique. A volume of pores having a diameter of 10 to 40 nm was 55% of the pore volume of the catalyst alone. From the comparison with the results of Comparative Example 1, it was confirmed that the penetration of the electrode electrolyte into the primary pores was suppressed.

### PREPARATION OF EXAMPLE 2

(3-1)

Sulfonated polyethersulfone having a smaller molecular weight than the Polymer B (hereinafter, referred to as Polymer C) was synthesized. The Polymer C had a number average molecular weight of 54000 and a sulfone group equivalent of 1.7 mmol/g.

(3-2)

The Polymer C synthesized in the above-described (3-1) was dipped into a 1M aqueous sodium hydroxide solution in advance, to substitute the proton of sulfonic acid by sodium, and dried at 120° C. for 2 hours. This Polymer C (10 g) was taken out, and the solvent mixture of 1-propanol, 2-propaol and water in a weight ratio of 80:80:20 (90 g) was dropped thereto. A sample bottle containing this mixture was placed in the water bath equipped with the ultrasonic generator, and irradiated with the ultrasonic wave to prepare the dispersion liquid C. The size of the dispersed particles in dispersion liquid C was measured using the dynamic light scattering measuring equipment, and a peak of distribution was ascertained to be around 450 nm.

(3-3)

A membrane-electrode assembly was prepared by the same procedures as in Example 1, except that the dispersion liquid C prepared in the above-described (3-2) was used for preparation of the Pt/C slurry for the cathode. The catalyst slurry prepared here was referred to as Slurry C.

(3-4)

From the membrane-electrode assembly prepared in the above-described (3-3), a cross-sectional slicing was carried out using the freezing microtome, and existence states of the carbon support and the Polymer C in the cathode electrode were confirmed using the SEM. Particulate agglomerates of 200 to 400 nm were ascertained in the electrode, and a highest frequency particle size was found to be 300 nm from the histogram. Elements of this agglomerate were analyzed using the EDX, and C, O and S were detected in higher contents, and it was ascertained that the electrode electrolyte contains the sufonic acid group.

(3-5)

In addition, Slurry C for cathode obtained in the above-described (3-3) was spray-coated on a polyimide sheet and dried. Pore size distribution of this dried one was evaluated using the mercury intrusion technique. The volume of the pores having a diameter of 10 to 40 nm was 50% of the pore volume of the catalyst alone. From the comparison with the results of Comparative Example 1, it was confirmed that the penetration of the electrode electrolyte into the primary pores is suppressed.

### PREPARATION OF EXAMPLE 3

(4-1)

The Polymer B solution obtained in the above-described (1-2) was poured in a spray-coating device, and sprayed the solution into water to obtain needle-like agglomerates of electrolyte. After the agglomerates were filtered and washed, a solvent mixture (90 g) of 1-propanol, 2-propanol and water was added to the agglomerates of electrolyte (10 g) to disperse. This was referred to as polymer dispersion liquid D.

(4-2)

A membrane-electrode assembly was prepared by the same procedures as in Example 1, except that polymer dispersion liquid D prepared in the above-described (3-1) was used for the preparation of the Pt/C slurry for the cathode.

(4-3)

From the membrane-electrode assembly prepared in the above-described (4-2), a cross-sectional slicing was carried out using the freezing microtome, and existence states of the carbon support and the Polymer B in the electrode were confirmed using the SEM. As a result, needle-like agglomerates of electrolyte having a length in its short axis direction of about 200 nm and a length in its long axis direction of 1000 nm were ascertained in the electrode. From this, it was also ascertained that the needle-like agglomerate contacts with each other, and proton conductive paths are formed three-dimensionally.

### PREPARATION OF EXAMPLE 4

(5-1)

Titanium oxide (TiO₂) was synthesized by dropping water to a mixture of titanium ethoxide (IV) and the ethylene glycol monomethyl ether, and hydrolyzing the titanium ethoxide. By a dynamic light scattering measurement of the synthesized TiO₂ dispersion liquid, it was confirmed that the particle size distribution of the synthesized TiO₂ had a peak at 300 nm.

(5-2)

The Polymer B solution prepared in the above-described (1-2) was added to the TiO₂ dispersion liquid obtained in the above-described (5-1) so that a weight ratio of TiO₂ to Polymer B became 2:1, and mixed together. This was referred to as dispersion liquid E.

(5-3)

A membrane-electrode assembly was prepared by the same procedures as in Example 1, except that the polymer dispersion liquid E prepared in the above-described (5-2) was used for the preparation of the Pt/C slurry for the cathode.

(5-4)

From the membrane-electrode assembly prepared in the above-described (5-3), a cross-sectional slicing was carried out using the freezing microtome, and existence states of the carbon support and the Polymer B in the electrode were ascertained using a SEM. Particulate agglomerates having a size of 400 nm was ascertained in the electrode, and the SEM-EDX measurement showed that Ti, O, S and C are contained. The electrode slice prepared using the freezing microtome was observed using the TEM, and a point analysis of composition of the particulate agglomerates was carried out by the TEM-EDX measurement. As a result, from the fact that relative intensities of Ti in the central part and S in the peripheral part were high, it was confirmed that the electrode electrolyte containing the sulfonic acid group is coating the outer circumference of TiO₂ particles.

### PREPARATION OF COMPARATIVE EXAMPLE 2

(6-1)

A membrane-electrode assembly was prepared by the same procedures as in Example 4, except that Nafion (R) instead of the Polymer B was used for the electrolyte to be added to the TiO₂ dispersion liquid in the above-described (5-2).

(6-2)

From the membrane-electrode assembly prepared in the above-described (6-1), a cross-sectional slicing was carried out using the freezing microtome, and existence states of the carbon support and Nafion (R) in the electrode were ascertained using the SEM. Particulate agglomerates having a size of 400 nm was ascertained in the electrode, and the SEM-EDX measurement showed that Ti, O, S, C and F are contained. The electrode slice prepared using the freezing microtome was observed using the TEM, and a point analysis of composition of the particulate agglomerates was carried out by the TEM-EDX measurement. As a result, from the fact that relative intensities of Ti in the central part and S and F in the peripheral part are high, it was confirmed that Nafion (R) is coating the outer circumference of TiO₂ particles.

### PREPARATION OF EXAMPLE 5

(7-1)

Polystyrene beads (produced by Techno Chemical Corp., Polybead Polystyrene Microsphere, particle size: 1 μm or less) were dispersed in a solvent mixture of 1-propanol, 2-propanol and water. The concentration of the dispersion liquid was 2.5% by weight.

(7-2)

The Polymer B solution prepared in (1-2) was added to the polystyrene beads dispersion liquid obtained in the above-described (7-1) so that a weight ratio of polystyrene to Polymer B became 1:1, and mixed together. This mixture was referred to as dispersion liquid F.

(7-3)

A membrane-electrode assembly was prepared by the same procedures as in Example 1, except that the dispersion liquid F prepared in the above-described (7-2) was used for the dispersion liquid to be used for preparation of the Pt/C slurry for the cathode.

### PREPARATION OF EXAMPLE 6

(8-1)

A carbon black produced by Lion Corp. (Ketjenblack) was dispersed in the solvent mixture composed of 1-propanol, 2-propanol and water (weight ratio=80:80:20), and the Polymer B solution prepared in the above-described (1-2) was mixed thereto so that the weight ratio of carbon to polymer became 1:0.8. This carbon slurry was subjected to an ultrasonic treatment and dried to obtain a solid in which the Polymer B coated the circumference of the carbon black. This solid was pulverized in a mortar, and the solid having a particle size of 1 μm or less was collected using a sieve. This solid was dispersed in the solvent mixture of 1-propanol, 2-propanol and water. This dispersion liquid was referred to as dispersion liquid G.

(8-2)

A membrane-electrode assembly was prepared by the same procedures as in Example 1, except that the dispersion liquid G prepared in the above-described (8-1) was used for the dispersion liquid to be used for preparation of the Pt/C slurry for the cathode.

### PREPARATION OF EXAMPLE 7

(9-1)

To a gas-phase process carbon fiber (10 g) produced by Showa Denko K. K. (VGCF (R), the solvent mixture containing 1-propanol, 2-propanol and water (weight ratio=40:40:20) (90 g) was added and mixed using ultrasonic wave. The Polymer B solution prepared in the above-described (1-2) was added thereto and mixed to prepare a slurry containing the carbon fiber and the polymer B.

(9-2)

The slurry prepared in the above-described (9-1) was coated on a polyimide sheet by spray method, and dried. The resultant dried one was pulverized to obtain a carbon fiber coated with the Polymer B. Solid particles having a particle size of 10 μm or less were collected using a sieve, and these particles was dispersed again in the solvent mixture of 1-propanol, 2-propanol and water. This dispersion liquid was referred to as dispersion liquid H.

(9-3)

A membrane-electrode assembly was prepared by the same procedures as in Example 1, except that the dispersion liquid H prepared in the above-described (9-2) was used for the dispersion liquid to be used for preparation of the Pt/C slurry for the cathode.

### PREPARATION OF EXAMPLE 8

(10-1)

TiO₂ prepared in the above-described (5-1) was added to the 2-propanol, and dispersed using the ultrasonic wave. After that, a solution of 3-aminopropyltriethoxysilane (APS) in 2-propanol was added thereto. After water corresponding to 5% of the weight of the 2-propanol was added, the dispersion liquid was heated up to 90° C. while stirred using a magnetic stirrer, left at rest for 1 hour, and filtered. The solid was rinsed with pure water. Surface composition of the resultant particles was evaluated by an X-ray photoelectron spectroscopy (XPS), and Si, C and N were detected besides Ti and O. From this fact, it was confirmed that the surface of TiO₂ had been modified with the APS. This material was referred to as APS-modified TiO₂.

(10-2)

The APS-modified TiO₂ obtained in the above-described (10-1) was added to the ethylene glycol monomethyl ether and dispersed, and the Polymer B solution prepared in the above-described (1-2) was added thereto so that a weight ratio of APS-modified TiO₂ to Polymer B became 2:1. This dispersion liquid was referred to as dispersion liquid I.

(10-3)

A membrane-electrode assembly was prepared by the same procedures as in Example 1, except that the polymer dispersion liquid I prepared in the above-described (10-2) was used for the dispersion liquid to be used for preparation of the Pt/C slurry for the cathode.

(10-4)

From the membrane-electrode assembly prepared in the above-described (10-3), an electrode slicing was carried out using the freezing microtome, and observed using the TEM. Point analysis of the composition of the particulate agglomerates was carried out by the TEM-EDX measurement. As a result, from the fact that the relative intensities of Ti in the central part and S in the peripheral part were high, and that a trace of N was detected from near the interface of the TiO₂ particle and the resin, it was confirmed that the electrode electrolyte containing the sulfonic acid group is coated on the outer circumference of the APS-modified TiO₂ particle.

### [Evaluation and Discussion on the Cathodes of the Membrane-Electrode Assembly Prepared]

(11-1)

Regarding the membrane-electrode assemblies of Comparative Example 1, Examples 1, 2 and 4 among the prepared membrane-electrode assemblies, an electrode part was coated with a gas diffusive layer, and set in an evaluation cell including a carbon separator. The evaluation cell was heated up to 80° C., and cyclic voltammetry was measured while hydrogen and nitrogen each at a relative humidity of 100% were flowed to the anode and the cathode, respectively. From the peak area originating from hydrogen desorption observed near at 0.1 to 0.3 V, an active surface area in the cathode was measured. Also, cell voltage at a current density of 0.25 A/cm² was measured while the hydrogen and air at the relative humidity of 100% were flowed to the anode and the cathode, respectively.

(11-2)

Cell voltages of the membrane-electrode assemblies are represented in Table 1. In the membrane-electrode assemblies of Examples 1, 2 and 4 compared with that of Comparative Example 1, the penetration of the electrolyte into the primary pores having a diameter of 10 to 40 nm was suppressed by adding the particulate media having the electrolyte on the surface. The membrane-electrode assemblies with a larger pore volume exhibit a larger active surface area of catalyst and a higher cell voltage. These results demonstrated that the suppression of intrusion of the electrolyte effectively heightened the catalyst utilization and the gas diffusivity, improving the cell voltage.

TABLE 1

| | Volume of pores | | |
|---|---|---|---|
| | of 10-40 nm | | |
| | (Volume of Pt/C | | |
| | catalysts without | | |
| | any binder is set to | Active surface area | |
| Sample | be 100) | (m²/g-Pt) | Cell voltage (V) |
| Example 1 | 70 | 55 | 0.60 |
| Example 2 | 45 | 45 | 0.65 |
| Example 4 | 45 | 45 | 0.66 |
| Comparative | 30 | 25 | 0.40 |
| Example 1 | | | |

(11-3)

In comparison with Example 1 in which the peak of particle size was about 1100 nm, in Examples 2 and 4 in which the peaks of particle size were about 300 and 400 nm, respectively, it is considered that the improvement in the cell voltage was significant because proton conductive paths are suitably formed. In addition, in comparison with Example 2, in Example 4 in which the particulate medium core was TiO₂, a higher cell voltage can be obtained, because the increase of the volume of the particulate medium due to the expansion of the electrolyte in the humidified atmosphere is suppressed.

(11-4)

In Examples 3 and 7, since the volume of the pores having a diameter of 10 to 40 nm is maintained at a high level, and further the proton conductive paths are easily formed, due to the effect of the needle-like media having the electrolyte on the surface, a higher cell voltage is obtained.

(11-5)

In Examples 5 and 6, since as well as the volume of the pores having a diameter of 10 to 40 nm is as high as Example 4, and since the expansion of the particulate media in the electrode is suppressed, a high cell voltage can be obtained.

(11-6)

In Example 4, Comparative Example 2 and Example 8 in which the TiO₂ particles were used as cores, the volume of the pores having a diameter of 10 to 40 nm is maintained at a high level due to the effect of the particulate media, a high cell voltage is obtained. In Examples 4 and 8 in comparison with Comparative Example 2, since the adhesive property of the electrolyte (aromatic hydrocarbon-based electrolyte having the cation-exchange group) on the particulate medium surface to the carbon support and the electrolyte membrane is high, electrode stability is superior. In particular, in Example 8 in which the electrolyte was coated on the surface of the APS-modified TiO₂, since the adhesive property between particulate media and electrolyte is also high, it is superior in the stability and, in particular, a high cell voltage can be obtained even in a long period of power generation.

Although the electrode of the present invention was applied only to the cathode in Examples 1 to 8, but even when the electrode is used for the anode, the cell voltage can be improved due to the improved catalyst utilization and the gas diffusivity. In addition, even when the electrode of the present invention is used for a membrane-electrode assembly for DMFC, the cell voltage of DMFC can be improved due to the improved catalyst utilization and the gas diffusivity.

An example in which a fuel cell using the membrane-electrode assembly of the present invention is mounted on a portable information terminal which is one example of the fuel cell power generation system, is illustrated in FIG. 8.

This portable information terminal has a foldable structure in which two sections are connected by a hinge 87 combining a holder of fuel cartridge 86.

One section has a part built-in with a display device 81 integrated with a touch-panel type input device and antenna 82.

Another section has a part mounting a main board 84 mounted with electronic devices and electronic circuits such as a fuel cell 83, a processor, volatile and non-volatile memories, a power control section, a fuel cell and secondary battery hybrid control, a fuel monitor, and others, and a lithium-ion secondary battery 85.

The portable information terminal thus obtained can be used as a more compact and more lightweight equipment due to high output power of fuel cell 83.

The present invention can be utilized for fuel cells represented by PEFC and DMFC.

It should be further understood by those skilled in the art that although the foregoing description has been made on embodiments of the invention, the invention is not limited thereto and various changes and modifications may be made without departing from the spirit of the invention and the scope of the appended claims.

1. A membrane-electrode assembly comprising an anode, a cathode and a polymer electrolyte membrane and having a constitution in which the polymer electrolyte membrane is interleaved between the anode and the cathode, wherein the anode and the cathode contain an agglomerate structure of carbon support formed with a plurality of carbon primary particles supporting catalyst particles, and particulate media having a polymer electrolyte on the surface thereof are contained between adjacent the agglomerate structures of carbon support.

2. The membrane-electrode assembly according to claim 1, having primary pores among the carbon primary particles constituting the agglomerate structure of carbon support, and having secondary pores among a plurality of the agglomerate structures of carbon support.

3. The membrane-electrode assembly according to claim 1, wherein the particulate media are formed with the polymer electrolyte.

4. The membrane-electrode assembly according to claim 3, wherein the particulate media are needle-like or rod-like particles.

5. The membrane-electrode assembly according to claim 1, wherein the particulate media are formed by coating the polymer electrolyte on particulate medium cores.

6. The membrane-electrode assembly according to claim 5, wherein the particulate medium cores are composed of either polystyrene-based resin particles, metal oxide particles or carbon particles.

7. The membrane-electrode assembly according to claim 5, wherein the particulate medium cores are needle-like or rod-like particles.

8. The membrane-electrode assembly according to claim 5, wherein an anion-exchange group is covalently bonded on a surface of the particulate medium core, and the surface of the particulate medium core is coated with a polymer electrolyte having a cation-exchange group.

9. The membrane-electrode assembly according to claim 1, wherein the particulate media have at least one of peak diameter in a particle size distribution thereof, and the peak diameter is ranged from 40 nm to 1 μm.

10. The membrane-electrode assembly according to claim 1, wherein an average diameter of the particulate media is larger than an average diameter of a plurality of the carbon primary particles supporting the catalyst particles.

11. The membrane-electrode assembly according to claim 1, wherein the polymer electrolyte contained in at least one of the anode and the cathode is formed with an aromatic hydrocarbon-based electrolyte having a cation-exchange group.

12. The membrane-electrode assembly according to claim 1, wherein the polymer electrolyte membrane is formed with an aromatic hydrocarbon-based electrolyte having a cation-exchange group.

13. A fuel cell using the membrane-electrode assembly according to claim 1.

14. A fuel cell power generation system using the fuel cell according to claim 13.

15. A method of producing a membrane-electrode assembly comprising an anode, a cathode and a polymer electrolyte membrane and having a constitution in which the polymer electrolyte membrane is interleaved between the anode and the cathode, comprising a step to prepare a particulate media dispersion liquid in which particulate media having a polymer electrolyte on a surface thereof is dispersed in a solvent, a step to prepare a catalyst slurry by mixing carbon particles supporting catalyst particles with the particulate media dispersion liquid, and a step to prepare the anode and the cathode by coating the catalyst slurry on a surface of the polymer electrolyte membrane.

16. The method of producing a membrane-electrode assembly according to claim 15, comprising a step to prepare the particulate media by coating a surface of a particulate medium core with the polymer electrolyte.

17. The method of producing a membrane-electrode assembly according to claim 16, comprising an anion-exchange group modification step to modify the surface of the particulate medium core with an anion-exchange group, and a step to prepare the particulate media by mixing the polymer electrolyte having a cation-exchange group.

18. The method of producing a membrane-electrode assembly according to claim 17, wherein the anion-exchange group modification step is a step to bind a silane coupling agent containing the anion-exchange group to the surface of the particulate medium core.
